(19) United States
(12) Patent Application Publication
(10) Pub. No.: US 2024/0075754 A1
(43) Pub. Date: Mar. 7, 2024

(54) LIGHT IRRADIATOR

(71) Applicant: KYOCERA CORPORATION, Kyoto-shi, Kyoto (JP)

(72) Inventor: Takayuki MIMA, Yasu-shi, Shiga (JP)

(21) Appl. No.: 18/261,484

(22) PCT Filed: Jan. 7, 2022
(86) PCT No.: PCT/JP2022/000382

§ 371 Date: Jul. 14, 2023

(30) Foreign Application Priority Data
Jan. 22, 2021 (JP) 2021-009179

(51) Int. Cl. B41J 11/00; B41J 29/377

(52) U.S. Cl. CPC B41J 11/00218; B41J 29/377

(57) ABSTRACT

A light irradiator includes a light source including a plurality of light-emitting elements, a blower for blowing toward the light source, a heat sink coupled to the light source, a housing accommodating the light source, the blower, and the heat sink and having an outlet adjacent to the heat sink and an inlet adjacent to the blower, and a partition in the housing. The partition divides an internal space of the housing into an air blowing space between the blower and the heat sink and a remaining space excluding the air blowing space.

### RELATED APPLICATIONS

The present application is a National Phase of International Application Number PCT/JP2022/000382 filed Jan. 7, 2022, which claims the benefit of priority from Japanese Patent Application No. 2021-009179, filed on Jan. 22, 2021.

### FIELD

The present disclosure relates to a light irradiator including a light source using, for example, multiple light-emitting diodes (LEDs) as light-emitting elements.

### BACKGROUND

A known technique is described in, for example, Patent Literature 1.

### CITATION LIST

### Patent Literature

Patent Literature 1: Japanese Unexamined Patent Application Publication No. 2018-206591

### BRIEF SUMMARY

A light irradiator according to one or more aspects of the present disclosure includes a light source including a plurality of light-emitting elements, a heat sink thermally coupled to the light source, a blower for blowing toward the heat sink, a housing accommodating the light source, the blower, and the heat sink and having an outlet adjacent to the heat sink and an inlet adjacent to the blower, and a partition in the housing. The partition divides an internal space of the housing into an air blowing space between the blower and the heat sink and a remaining space excluding the air blowing space.

### BRIEF DESCRIPTION OF DRAWINGS

The objects, features, and advantages of the present disclosure will become more apparent from the following detailed description and the drawings.

FIG. 1 is a perspective view of an example light irradiator 1 according to an embodiment of the present disclosure.

FIG. 2 is a perspective view of the light irradiator 1 without showing a top surface 13.

FIG. 3 is a side view of the light irradiator 1 without showing a third side wall 15.

FIG. 4 is a perspective view of a partition 11.

FIG. 5 is a perspective view of the light irradiator 1 without showing a first side wall 17.

FIG. 6 is a side view of the light irradiator 1 without showing the first side wall 17.

FIG. 7 is a plan view of the light irradiator 1 without showing the top surface 13.

### DETAILED DESCRIPTION

The recent advancement of light-emitting diodes (LEDs) as light-emitting elements allows a large number of LEDs to be mountable in a space-saving small area of an LED module, and also allows such LEDs to be brighter. Thus, the area on which such LEDs are mounted tends to generate more heat. In response to the above issue, light irradiators are expected to have more efficient heat discharge to avoid temperature increase in LEDs resulting from heat generation. The LEDs are thermally coupled to a heat sink including multiple fins, through which cooling air as a refrigerant passes, thus increasing heat transfer from the LEDs to the cooling air in the heat sink. A method for increasing heat discharge with the heat sink is the use of larger fins in the heat sink. However, such larger fins alone do not sufficiently cool the LEDs. The light irradiator has a limited space for the heat sink, thus limiting the sizes of the fins. Light irradiators are thus expected to cool LEDs more efficiently without upsizing the heat sink.

A light irradiator with the structure that forms the basis of the structure according to one or more embodiments of the present disclosure includes a housing, a light source adjacent to a first surface as one of surfaces defining the housing, a heat sink including a fin adjacent to the light source, and an inlet at a position away from the first surface in a first direction orthogonal to the first surface. The fin includes multiple plates with the plate surfaces each including a first area and second areas each having a shorter length in the first direction than the first area. The second areas are separated from one another parallel to the first surface. The fin includes an inflow portion opposite to the first surface in the first direction and including a separating portion in which the first areas in the multiple plates are separated from one another, and outflow portions at positions different from the position of the inflow portion in a direction parallel to the first surface and including separating portions in which the plate surfaces are separated from one another. The light irradiator includes an air guide for covering a part of the separating portion, in which the first areas are separated from one another, and including surfaces parallel to the first direction. A light irradiator may have this structure to efficiently cool LEDs without being upsized.

In such a light irradiator, a small fan used for a large-capacity heat sink can generate an unstable airflow and thus fail to sufficiently cool LEDs. In such a light irradiator, a large amount of air may also fail to pass through the heat sink and to be used in heat transfer, and some air flows to low-temperature areas, thus possibly causing the heat sink to be inefficient in transferring heat. One or more aspects of the present disclosure are directed to a light irradiator that can cause a fan to efficiently blow air toward a heat-dissipating member, can generate a stable airflow with the fan that may be small and used for a large-capacity heat sink, and can thus sufficiently cool the components.

A light irradiator according to one or more embodiments of the present disclosure will now be described with reference to the accompanying drawings.

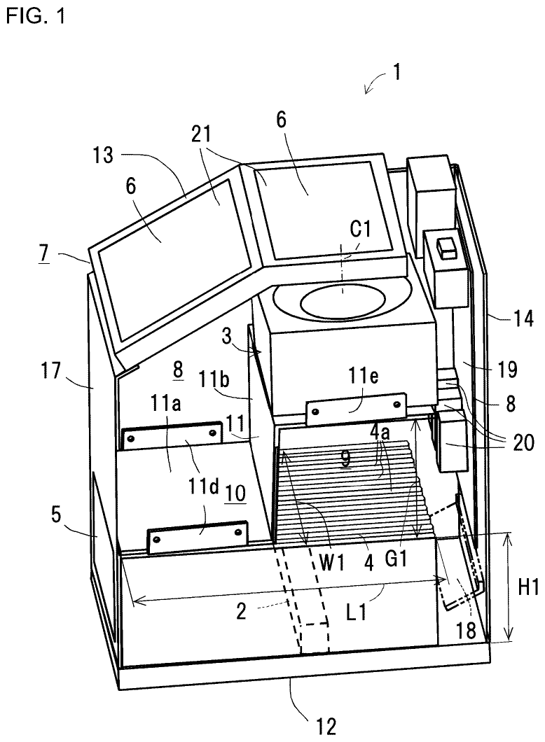

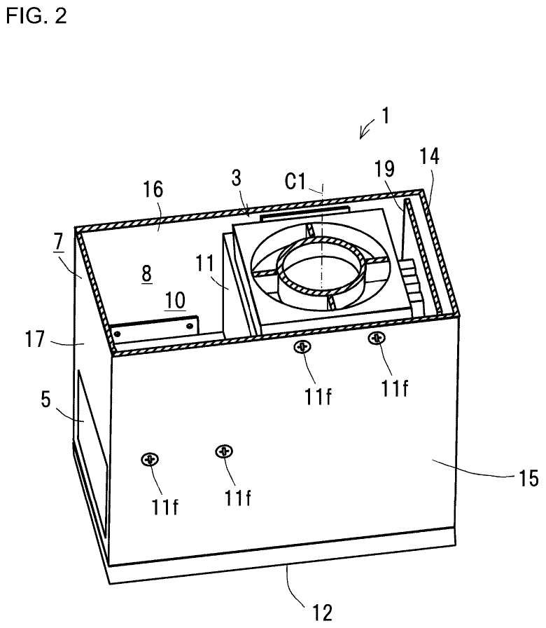

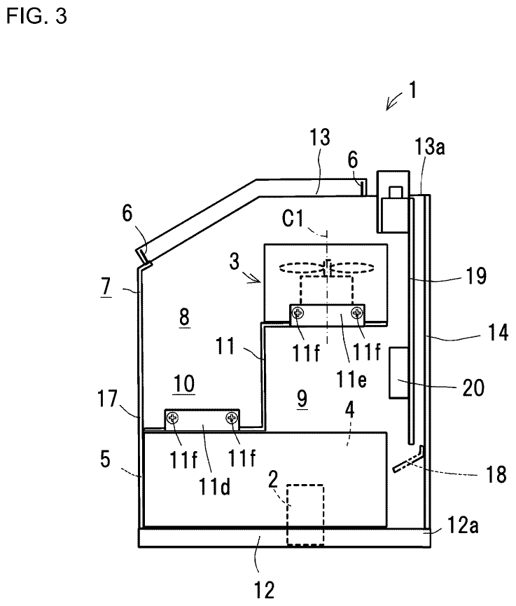

FIG. 1 is a perspective view of an example light irradiator 1 according to an embodiment of the present disclosure. FIG. 2 is a perspective view of the light irradiator 1 without showing a top surface 13 of a housing 7. FIG. 3 is a side view of the light irradiator 1 without showing a third side wall 15. The light irradiator 1 according to the present embodiment includes a light source 2 including multiple light-emitting elements, a heat sink 4 thermally coupled to the light source 2, a blower 3 to blow toward the heat sink 4, the housing 7 accommodating the light source 2, the blower 3, and the heat sink 4 and having an outlet 5 adjacent to the heat sink 4 and inlets 6 adjacent to the blower 3, and a partition 11, included in the housing 7, dividing an internal space 8 in the housing 7 into an air blowing space 9 between the blower 3 and the heat sink 4 and a remaining space 10 excluding the air blowing space 9. The inlets 6 adjacent to the blower 3 may not be so close to the blower 3 as the outlet 5 adjacent to the heat sink 4 is to the heat sink 4. However, the blower 3 is to be close enough to the inlets 6 to have the distance between the blower 3 and the inlets 6 that is substantially shorter than the distance between the blower 3 and the heat sink 4.

The housing 7 has a bottom surface 12 facing the emission direction of light from the light source 2 and including a light emission window (not shown), the top surface 13 opposite to the bottom surface 12 and adjacent to the blower 3, and having the inlets 6, an inclined surface, and a horizontal surface, a first side wall 17 having the outlet 5 adjacent to the heat sink 4 and being connected to the bottom surface 12 and the inclined surface of the top surface 13, a second side wall 14 extending between a first edge 12a of the bottom surface 12 and a second edge 13a of the horizontal surface of the top surface 13 opposite to the first edge 12a of the bottom surface 12, the third side wall 15 being connected to the bottom surface 12, the top surface 13, and the second side wall 14, and a fourth side wall 16 being opposite to the third side wall 15 and being connected to the bottom surface 12, the top surface 13, and the second side wall 14.

The housing 7 defines the profile of the light irradiator 1. The housing 7 is formed from a metal or a plastic. The housing 7 in the present embodiment is substantially a rectangular prism. The housing 7 with the top surface 13 including the inclined surface and the horizontal surface appears to be a pentagon, or a rectangle with its one corner cut away, as viewed laterally. The bottom surface 12 serving as an emission surface of the light irradiator 1 includes the light emission window facing the emission direction of light from the light source 2.

The light source 2 facing the light emission window and the heat sink 4 thermally coupled to the light source 2 are located on the bottom surface 12. The heat sink 4 includes multiple fins 4a formed from a highly thermally conductive metal, such as aluminum or copper. The heat sink 4 may be a rectangular metal block formed from aluminum or copper and cut to have many grooves to increase its surface area (remaining portions serve as the fins 4a). The heat sink 4 may be a flat metal plate formed from aluminum or copper and receiving many thin plates formed from aluminum or copper attached to the flat metal plate. The thin plates serve as the fins 4a and allow air to flow between the plates. The heat sink 4 attached to the bottom surface 12 or to the third side wall 15 and the fourth side wall 16 is accommodated at a predetermined position in the housing 7.

The light source 2 includes multiple light-emitting elements. The light-emitting elements are mounted on a light source board (not shown) including, for example, a ceramic wiring board, and form the light source 2. The heat sink 4 may be connected to the light source board in the light source 2 with, for example, thermal grease. The grease increases the adhesion between the heat sink 4 and the light source board to improve thermal connection. This structure increases heat dissipation from the light source 2 with the heat sink 4. The light-emitting elements used for the light source 2 are, for example, LEDs that emit ultraviolet light. Such LEDs may be GaN LEDs. In some embodiments, the LEDs may emit infrared light. Such LEDs may be GaAs LEDs. The light-emitting elements in the light source 2 may be selectable in accordance with the wavelength to be used.

The partition 11 includes, for example, a first wall 11a, a second wall 11b perpendicularly connected to the first wall 11a, and a pair of mounting pieces 11c perpendicularly connected to the second wall 11b. In the embodiment according to the present disclosure, the blower 3 attached extends between the pair of mounting pieces 11c. The first wall 11a includes, for example, a pair of mounting flanges 11d. Each mounting piece 11c includes, for example, a mounting flange 11e. The mounting flanges 11d and the mounting flanges 11e are fastened with screw members 11f, such as screws, bolts, or rivets, at predetermined positions on the third side wall 15 and the fourth side wall 16. The partition 11 extends from the blower 3 to the heat sink 4 and from the third side wall 15 to the fourth side wall 16. The blower 3 uses most of the space between the third side wall 15 and the fourth side wall 16. The blower 3 is adjacent to the second side wall 14 and away from the first side wall 17. In the embodiment according to the present disclosure, the space between the heat sink 4 at the bottom of the housing 7 and the blower 3 above the heat sink 4 is the air blowing space 9 in the internal space 8. The space between the air blowing space 9 and the first side wall 17 is the remaining space 10 in the internal space 8. The partition 11 in the embodiment according to the present disclosure is located between the blower 3 and the heat sink 4 and between the third side wall 15 and the fourth side wall 16 to divide the internal space 8 into the air blowing space 9 and the remaining space 10 in accordance with the arrangement of the blower 3 and the heat sink 4.

The light irradiator 1 further includes a guide 18 on the second side wall 14. The guide 18 is in the air blowing space 9 in the housing 7 and guides the airflow from the blower 3 to the air blowing space 9 toward the heat sink 4. The guide 18 may be located beside the heat sink 4 and above the corner between the bottom surface 12 and the second side wall 14 as shown in, for example, FIG. 3. The guide 18 can efficiently guide the airflow that tends to stagnate at the corner toward the heat sink 4, thus increasing heat dissipation with the heat sink 4. The guide 18 may be designed to have an appropriate width, length, angle, and position, or more guides 18 may be used, to contribute to an effective airflow setting in the housing 7 based on, for example, the positional relationship between the blower 3, the heat sink 4, and a drive board 19. Although the guide 18 shown in FIG. 3 is a plate bending and diagonally extending from its attachment on the second side wall 14 toward the heat sink 4, the present disclosure is not limited to this example. The guide 18 may be, for example, a block having an inclined surface diagonally extending from the second side wall 14 to the heat sink 4 and being triangular or trapezoidal as viewed laterally.

The light irradiator 1 further includes the drive board 19 located along the second side wall 14 to drive the light source 2 and the blower 3. The drive board 19 includes a drive circuit for powering the light-emitting elements in the light source 2 and controlling their light emission. The drive board 19 may also drive the blower 3 and control the amount of air from the blower 3 in accordance with heat generation from the light source 2. The drive board 19 further includes multiple heat generating components 20, or electronic components, such as power transistors, that typically tend to reach high temperatures. The heat generating components 20 are placed in the air blowing space 9 for heat dissipation. This allows the drive board 19 on which the heat generating components 20 are mounted to efficiently dissipate heat together with the heat sink 4. The housing 7 may include grooves, fins, air deflectors, or other components on its inner surface to allow air to effectively flow to parts of the drive board 19 that tend to reach high temperatures.

The blower 3 may be an axial fan including blades rotatable about a central axis Cl extending toward the heat sink 4. The blower 3 accommodated in the housing 7 generates the flow of outside air (air) from the multiple inlets 6 to the outlet 5. The blower 3 may be an axial fan with a small size that generates a large airflow. The blower 3 may be any other type of blower such as a centrifugal fan. Such a blower 3 with small dimensions, or for example, with a length of 60 mm, a width of 60 mm, and a height of 38 mm, can thus generate a large cooling airflow of, for example, about 2.25 m³/min With a duct structure including the partition 11 together with the third side wall 15, the fourth side wall 16, and the second side wall 14, the blower 3 supplies the airflow to the heat sink 4 without allowing the airflow to escape outside the air blowing space 9 and blows a stable amount of air into spaces between the multiple fins 4a. This sufficiently cools the light source 2. In the simple structure additionally including the partition 11 including plates, the housing 7 can have the efficient air blowing space 9. The blower 3 blows air into the air blowing space 9 to cause the air blowing space 9 to become under positive pressure (positive pressure) higher than atmospheric air pressure to generate a laminar airflow without turbulence. The blower 3 then causes the airflow to efficiently and uniformly pass through the spaces between the multiple fins 4a. The blower 3 can maximize heat removal through heat exchange between the fins 4a and the airflow by increasing the amount of air passing through between the fins 4a. The blower 3 maintains blow of the increased amount of air and can stably and sufficiently cool the light-emitting elements. This allows the multiple driving light-emitting elements used for the light source 2 to have a constant temperature and stable and constant brightness distribution of light emitted from the light-emitting elements.

The heat sink 4 in the light irradiator 1 according to the present embodiment including such a blower 3 may have, for example, a depth W1 of 77 mm, a length L1 of 119 mm, and a height H1 of 47 mm in FIG. 1

Each inlet 6 includes a filter 21. The filter 21 may include, for example, a sponge or a nonwoven fabric. The filter 21 prevents foreign matter such as dust and dirt in outside air from entering the housing 7, and thus prevents the decrease in heat dissipation from the light source 2 or the drive board 19 and malfunctions caused by a short circuit in the wiring in the heat sink 4 or in the drive board 19 due to dust and dirt accumulating on the heat sink 4 or the drive board 19. This improves the reliability of the light irradiator 1. The attached filter 21 can regulate airflows and thus can decelerate the flow of outside air around the inlet 6. In addition, the filter 21 absorbs operational sounds of the axial fan in the blower 3 accommodated in the housing 7, possibly decreasing noise generated by the axial fan in the light irradiator 1.

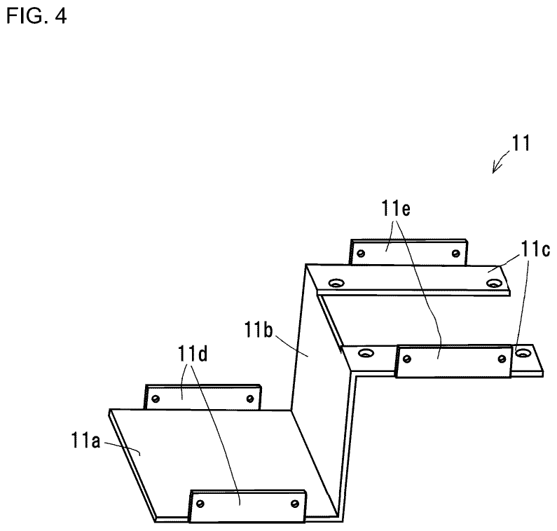

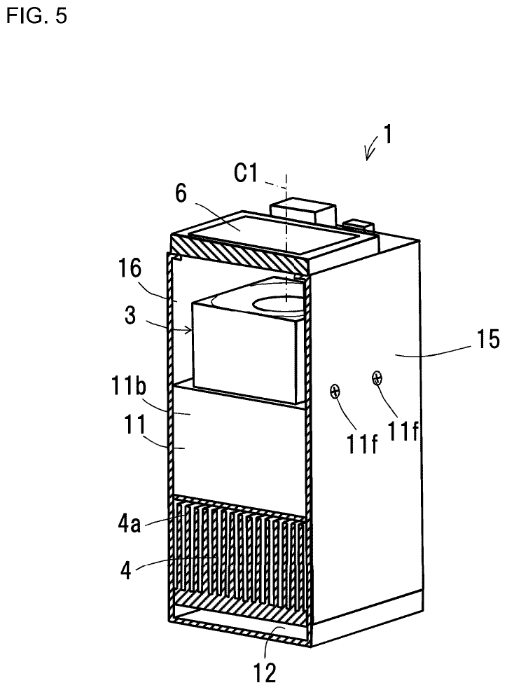

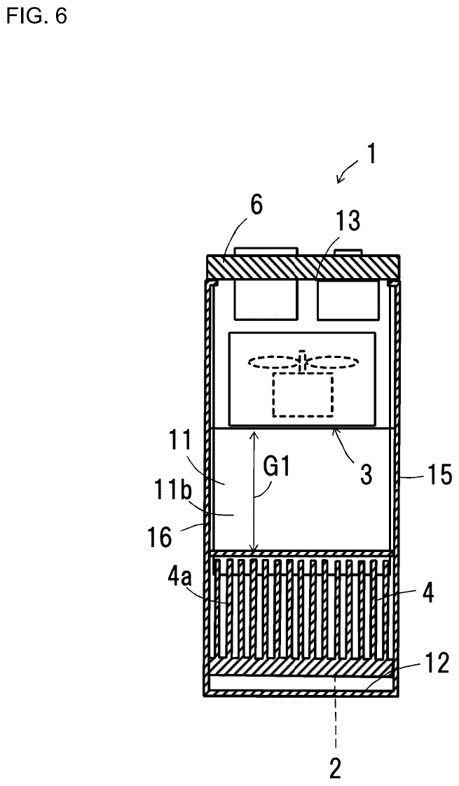

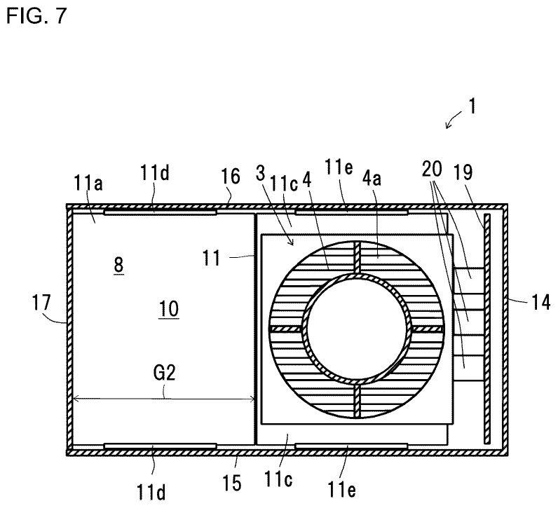

FIG. 4 is a perspective view of the partition 11. FIG. 5 is a perspective view of the light irradiator 1 without showing the first side wall 17. FIG. 6 is a side view of the light irradiator 1 without showing the first side wall 17. FIG. 7 is a plan view of the light irradiator 1 without showing the top surface 13. A housing 7 in a light irradiator with the structure that forms the basis of the structure according to one or more embodiments of the present disclosure, including the same components as in the light irradiator 1 excluding the partition 11, has the outer dimensions of, for example, the depth of 80 mm, the length of 162 mm, and the height of 182 mm. In contrast, the light irradiator 1 including the partition 11 that increases heat dissipation with the heat sink 4 can downsize the housing 7 to have the outer dimensions of the length of 140 mm and the height of 170 mm. In the light irradiator 1, the outlet 5 may have, for example, the internal dimensions of the depth of 68 mm, the height of 40 mm, a gap G1 of 51 mm between the heat sink 4 and blower 3, and a gap G2 of 61 mm between the blower 3 and the first side wall 17.

To determine the cooling performance of the light irradiator 1 described above, the inventor of the present disclosure fastened a thermistor to the heat sink 4 at a site immediately adjacent to an LED module, which corresponds to an LED module mounting surface in the light source 2, with screws, and measured any temperature increases of the driving light source 2 and the non-driving light source 2 from room temperature. In a light irradiator with the same arrangement of the components in a housing 7 as in the housing 7 in the light irradiator 1 excluding the partition 11, the temperature of the driving light source 2 was saturated at about 80° C. after five-minute driving. In contrast, in the above light irradiator 1 including the partition 11, the temperature of the driving light source 2 was saturated at about 72° C. after five-minute driving. The light-emitting elements have 15° C. higher temperatures than the temperatures at the measurement site during driving. The results show that the light irradiator 1 according to one or more embodiments of the present disclosure including the partition 11 in the housing 7 downsizes the housing 7 compared with a housing in a light irradiator with the structure that forms the basis of the structure according to one or more embodiments of the present disclosure, lowers the temperatures of the driving light-emitting elements in the light source 2, and shows sufficient cooling performance

The present disclosure may be implemented in the following forms.

A light irradiator according to one or more embodiments of the present disclosure includes a light source including a plurality of light-emitting elements, a heat sink thermally coupled to the light source, a blower for blowing toward the heat sink, a housing accommodating the light source, the blower, and the heat sink and having an outlet adjacent to the heat sink and an inlet adjacent to the blower, and a partition in the housing. The partition divides an internal space of the housing into an air blowing space between the blower and the heat sink and a remaining space excluding the air blowing space.

The light irradiator according to one or more embodiments of the present disclosure includes the partition that divides the air blowing space between the blower and the heat sink from the remaining space in the internal space of the housing. Although a small blower blows air to cool a large-capacity heat sink as with the known technique, such a partition can efficiently increase the amount of air passing through the heat sink and involved in heat transfer, thus improving heat transfer. The heat sink can thus stably receive a low-temperature airflow immediately before being in contact with the heat sink and having temperature increase, thus improving heat transfer. This heat sink can effectively cool the light source.

Although the embodiments of the present disclosure have been described in detail, the present disclosure is not limited to the embodiments described above, and may be changed or modified in various manners without departing from the spirit and scope of the present disclosure. The components described in the above embodiments may be entirely or partially combined as appropriate unless any contradiction arises.

### INDUSTRIAL APPLICABILITY

Ultraviolet light irradiators are common as light sources for curing, drying, melting, softening, or reforming target objects such as protective films, adhesives, paints, ink, photoresists, resins, or alignment films. A recent ultraviolet light irradiator includes LEDs that emit light in the ultraviolet range. The light irradiator according to one or more embodiments of the present disclosure can be implemented as a light source including an ultraviolet light source unit using such light-emitting elements (LEDs) that emit light in the ultraviolet range. The light irradiator including the above LEDs may be implemented for curing ink in printers such as inkjet printers using ultraviolet curable ink.

1. A light irradiator, comprising:
a light source including a plurality of light-emitting elements;
a heat sink thermally coupled to the light source;
a blower for blowing toward the heat sink;
a housing accommodating the light source, the blower, and the heat sink, the housing having an outlet adjacent to the heat sink and an inlet adjacent to the blower; and
a partition in the housing, the partition dividing an internal space of the housing into an air blowing space between the blower and the heat sink and a remaining space excluding the air blowing space.

2. The light irradiator according to claim 1, wherein
the housing includes
a bottom surface facing an emission direction of light from the light source and including a light emission window,
a top surface opposite to the bottom surface and adjacent to the blower, the top surface having the inlet,
a first side wall having the outlet and being connected to the bottom surface and the top surface,
a second side wall extending between a first edge of the bottom surface and a second edge of the top surface, the second edge being opposite to the first edge of the bottom surface,
a third side wall connected to the bottom surface, the top surface, and the second side wall, and
a fourth side wall opposite to the third side wall and connected to the bottom surface, the top surface, and the second side wall.

3. The light irradiator according to claim 2, wherein
the partition extends from the blower to the heat sink and from the third side wall to the fourth side wall.

4. The light irradiator according to claim 2, further comprising:
a guide located on the second side wall to guide an airflow from the blower to the air blowing space toward the heat sink.

5. The light irradiator according to claim 2, further comprising:
a drive board located along the second side wall to drive the light source and the blower.

6. The light irradiator according to claim 1, wherein
the blower includes an axial fan including blades rotatable about a central axis extending toward the heat sink.
